(19) United States
(12) Patent Application Publication
(10) Pub. No.: US 2011/0005349 A1
(43) Pub. Date: Jan. 13, 2011

(54) GEARMOTOR ASSEMBLY

(76) Inventors: Jian Luo, Hong Kong (CN); Xian Tang, Shenzhen (CN); Xuan Li Yang, Shenzhen (CN)

Correspondence Address: Muncy, Geissler, Olds & Lowe, PLLC, 4000 Legato Road, Suite 310, FAIRFAX, VA, 22033, US

(21) Appl. No.: 12/832,595

(22) Filed: Jul. 8, 2010

(30) Foreign Application Priority Data
Jul. 9, 2009 (CN) 200910108717.7

(51) Int. Cl. F16H 57/02; F16J 15/06

(52) U.S. Cl. 74/606 R

(57) ABSTRACT

A gearmotor assembly has a motor; and a gearbox attached to the motor. The gearbox has: a case having an opening, a cover for closing the opening, and a seal for sealing the cover to the case. The seal is a continuous loop disposed about the opening and having first and second axial end surfaces forming a first seal surface and a second seal surface. Two ridges are formed on each of the two seal surfaces, each of the ridges extending along the seal surface to form a continuous ridge. The two ridges of the first seal surface are spaced from each other and pressed by the case and the two ridges of the second seal surface are spaced from each other and pressed by the cover, whereby the seal is resiliently deformed between the case and the cover.

### CROSS REFERENCE TO RELATED APPLICATIONS

This non-provisional patent application claims priority under 35 U.S.C. §10 9(a) from Patent Application No. 200910108717.7 filed in The People's Republic of China on Jul. 8, 2009.

### FIELD OF THE INVENTION

This invention relates to a gearmotor assembly and in particular to a gearmotor assembly such as a window lift drive used in a vehicle to raise or lower a window.

### BACKGROUND OF THE INVENTION

A gearmotor assembly such as a window lift drive comprises a motor and a gearbox. The gearbox comprises a case having an opening, gears received in the case, and a cover for closing the opening of the case. The interface between the case and the cover should be sealed to prevent moisture or any other contaminants entering therein and grease from escaping. A seal in the form of a rubber ring having an O-shaped cross section is typically used to seal the gap between the case and the cover by nipping or clamping the seal between the case and the cover. However, the O-shaped cross section does not always provide a successful seal as adequate contact pressure between the cover and the case can not always be maintained all around the edge of the opening due to material warpage and manufacturing tolerances, etc. Previous attempts to solve this problem usually involve increasing the clamping force between the case and the cover. This has varying degrees of success but results in either a larger than necessary attachment between the cover and case increasing the size of the gearbox or the excessive force results in distortion of the cover and/or case compromising the seal and reducing the life of the gearmotor.

Hence, there is a desire for a gearmotor assembly with improved sealing between the case and the cover.

### SUMMARY OF THE INVENTION

Accordingly, in one aspect thereof, the present invention provides a gearmotor assembly, comprising a motor; and a gearbox attached to the motor, the gearbox comprising: a case having an opening, a cover for closing the opening, and a seal for sealing the cover to the case; wherein the seal is a continuous loop disposed about the opening and having first and second axial end surfaces forming a first seal surface and a second seal surface, at least two ridges being formed on each of the two seal surfaces, each of the ridges extending along the seal surface to form a continuous ridge, the at least two ridges of the first seal surface being spaced from each other and being pressed by the case, the at least two ridges of the second seal surface being spaced from each other and being pressed by the cover, whereby the seal is resiliently deformed between the case and the cover.

Preferably, each of the seal surfaces has two continuous ridges which are spaced from each other so that the seal has a H-shaped radial cross section.

Preferably, the seal is a rubber ring.

Preferably, the seal forms a regular circle and each of the ridges is a continuous circular ridge.

Preferably, the axial height of each ridge is between 15% to 30% of the axial height of the seal.

Preferably, the case comprises a groove for receiving the seal, the groove being formed in an interface surface of the case surrounding the opening and facing the cover.

Preferably, each of the ridges has a rounded apex and two converging side walls, the side walls forming an angle between 50 and 80 degrees.

Preferably, the gearmotor assembly is a window lift motor for moving a window in a vehicle.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labelled with a same reference numeral in all the figures in which they appear. Dimensions of components and features shown in the figures are generally chosen for convenience and clarity of presentation and are not necessarily shown to scale. The figures are listed below.

FIG. 1 illustrates a gearmotor assembly according to the preferred embodiment of the present invention;

FIG. 2 is a sectional view of a gearbox being a part of the gearmotor assembly of FIG. 1;

FIG. 3 is an enlarged sectional view of a portion of the gearbox of FIG. 2;

FIG. 4 illustrates a seal, being a part of the gearbox of FIG. 2; and

FIG. 5 illustrates a segment of the seal shown in FIG. 4.

### DETAILED DESCRIPTION OF THE PREFERRED EMBODIMENTS

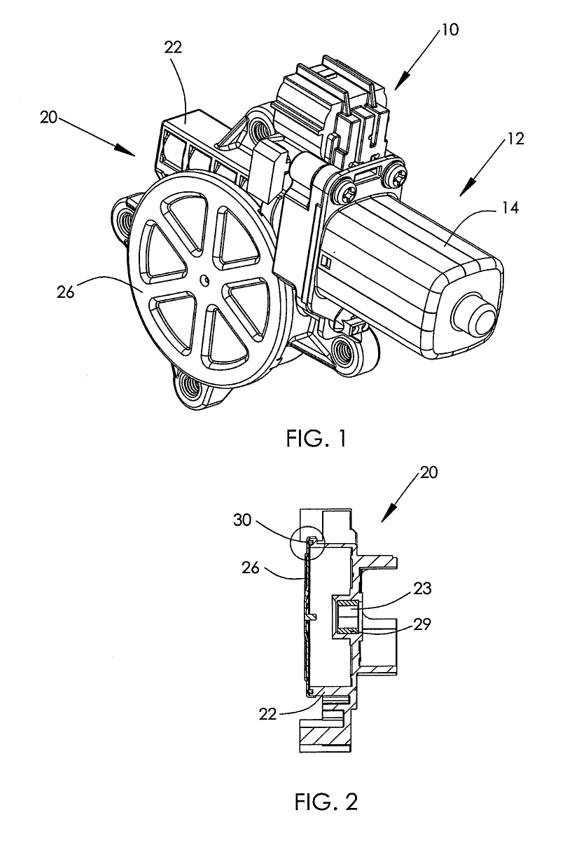

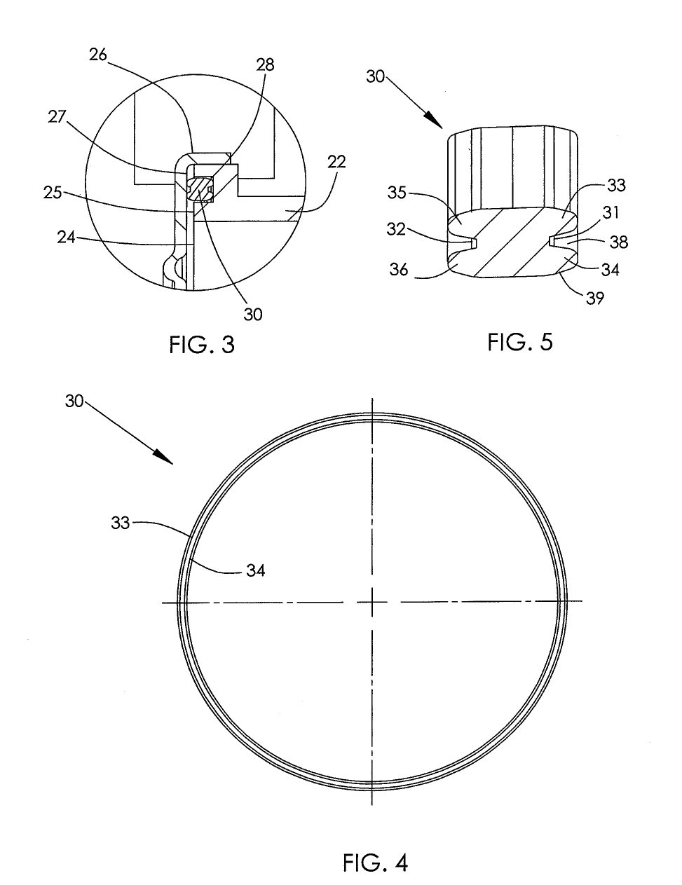

The gearmotor assembly 10 of FIG. 1 comprises a motor 12 and a gearbox 20. The motor has a motor housing 14 to which a case 22 of the gearbox is attached. The case accommodates gears (not shown) driven by the motor and forming a speed reduction gear train between the motor and an output shaft (not shown) of the gearbox, as is generally known. The case 22 has a hole 23 through which the output shaft extends for driving an attachment, such as a window in a door of a vehicle. Hole 23 is shown fitted with a bearing 29 for supporting the output shaft.

The case 22 also has a large opening 24 through which the gears are assembled into the gearbox. Opening 24 is closed by a cover 28. The case has a substantially flat surface surrounding the opening forming an interface surface 25 which confronts a corresponding interface surface 27 of the cover 26. The cover is sealed to the case by a seal 30 provided in the interface between the case and the cover to prevent moisture and other contaminates from entering the gearbox and to prevent leakage of oil or grease from the gearbox. The seal 30, in the form of a continuous rubber ring, is disposed between and resiliently deformed by the interface surfaces 25, 27. A groove 28 is formed in one of the interface surfaces, preferably interface surface 25 of the case, to locate the seal 30.

The seal 30 is used to seal the cover 26 to the opening 24. The seal 30 is a closed loop resilient rubber ring. The seal 30 comprises two seal surfaces 31 and 32, which are formed on opposite axial surfaces of the seal 30. When the cover 20 is fully assembled to the case, one of the seal surfaces such as seal surface 31 is pressed by the bottom of the groove 28 formed in the interface surface 25 of the case and the other one of the seal surfaces, such as seal surface 32 is pressed by the interface surface 27 of the cover 26.

FIG. 4 illustrates the seal 30 by itself and FIG. 5 illustrates a small segment of the seal 30. While the seal is shown as a rubber ring in the shape of a regular circle, in practice, the shape of the ring formed by the seal will suit the application and may be any desired closed loop or circular shape. As shown in FIG. 5, there are two ridges on each of the seal surfaces 31, 32. Two ridges 33, 34 are formed on seal surface 31. Each of the ridges 35, 36 extends along a circumferential direction and forms a closed circular ridge. The two closed circular ridges 35, 36 have different diameters so that the two circular ridges 35, 36 are spaced from each other in a radial direction of seal 30. Similarly, on seal surface 32, two ridges 35, 36 are formed, so that seal 30 has an H-shaped radial cross section. When the cover 26 is fitted to the case 22 , the two ridges 33, 34 are pressed by the case 22 and the two ridges 35, 36 are pressed by the cover 26 so that a multiline seal between the case 22 and the cover 26 is achieved. Compared with existing standard rings with an O-shaped cross section, the seal 30 according to the present invention comprises more than one continuous ridge on each seal surface, and the ridges on a same seal surface are radially spaced from each other, so that an improved seal is achieved.

A continuous circular valley is formed between the ridges on each seal surface. The axial height of each ridge is measured from the axial peak or apex of the ridge to the bottom of the corresponding valley in the axial direction of the seal 30. The axial height of the seal is measured from an axial peak of one ridge formed on one seal surface to an axial peak of another ridge formed on the other seal surface in the axial direction of the seal 30. The axial height of each ridge is preferably equal to between 15% to 30% of the axial height of the seal 30. In the preferred embodiment, the axial height of each ridge is about 25% of the axial height of the seal 30.

Each ridge, such as ridge 34, has a rounded apex and two converging side walls 38, 39. The angle formed by the two side walls 38, 39 is between 50 to 80 degrees. Preferably, the angle is about 60 degrees.

As described above, in the preferred embodiment the seal 30 comprises two seal surfaces 31 and 32 formed on respective axial end surfaces of the seal 30 and two spaced closed circular ridges are formed in each seal surface. However, it should be apparent to a person skilled in the art that more than two ridges can be formed in each seal surface.

In addition, the seal 30 according to the preferred embodiment is a circular ring. However, it should be apparent to a person skilled in the art that the seal can be any form of continuous loop, such as a rectangular ring, an elliptical ring, a wavy loop, an irregular loop, etc. and is not to be limited to forming a true circle.

Further more, while the interface between the case and the cover is preferably flat, it may be otherwise, provided that the gap between the cover and the case in which the seal is located is substantially constant so that the seal makes substantially continuous line contact with the case and the cover.

The gearmotor assembly according to the preferred embodiments is preferably a gearmotor known as a window lift motor as used in a vehicle for raising and lowering or otherwise moving a window. The gearbox typically comprises a worm gear driven by a worm fixed to the shaft of the motor.

In the description and claims of the present application, each of the verbs “comprise”, “include”, “contain” and “have”, and variations thereof, are used in an inclusive sense, to specify the presence of the stated item but not to exclude the presence of additional items.

Although the invention has been described with reference to one or more preferred embodiments, it should be appreciated by those skilled in the art that various modifications are possible. Therefore, the scope of the invention is to be determined by reference to the claims that follow.

1. A gearmotor assembly, comprising a motor; and a gearbox attached to the motor, the gearbox comprising:
a case having an opening,
a cover for closing the opening, and
a seal for sealing the cover to the case;
wherein the seal is a continuous loop disposed about the opening and having first and second axial end surfaces forming a first seal surface and a second seal surface, at least two ridges being formed on each of the two seal surfaces, each of the ridges extending along the seal surface to form a continuous ridge, the at least two ridges of the first seal surface being spaced from each other and being pressed by the case, the at least two ridges of the second seal surface being spaced from each other and being pressed by the cover, whereby the seal is resiliently deformed between the case and the cover.

2. The assembly of claim 1, wherein each of the seal surfaces has two continuous ridges which are spaced from each other so that the seal has a H-shaped radial cross section.

3. The assembly of claim 1, wherein the seal is a rubber ring.

4. The assembly of claim 1, wherein the seal forms a regular circle and each of the ridges is a continuous circular ridge.

5. The assembly of claim 1, wherein the axial height of each ridge is between 15% to 30% of the axial height of the seal.

6. The assembly of claim 1, wherein the case comprises a groove for receiving the seal, the groove being formed in an interface surface of the case surrounding the opening and facing the cover.

7. The assembly of claim 1, wherein each of the ridges has a rounded apex and two converging side walls, the side walls forming an angle between 50 and 80 degrees.

8. The assembly of claim 1, wherein the gearmotor assembly is a window lift motor for moving a window in a vehicle.
